(19) United States
(12) Patent Application Publication
(10) Pub. No.: US 2018/0160700 A1
(43) Pub. Date: Jun. 14, 2018

(54) Alcohol-Containing Candy Product

(71) Applicant: Giuseppe Puca, Krefeld (DE)

(72) Inventor: Giuseppe Puca, Krefeld (DE)

(21) Appl. No.: 15/737,376

(22) PCT Filed: Jun. 20, 2016
(86) PCT No.: PCT/EP2016/064138

§ 371 Date: Dec. 18, 2017

(30) Foreign Application Priority Data
Jun. 18, 2015 (EP) 15172734.4

(51) Int. Cl. A23G 3/54; A23G 3/56; A23G 3/34; A23G 3/42

(52) U.S. Cl. CPC A23G 3/545; A23G 3/563; A23V 2002/00; A23G 3/42; A23G 3/0065

(57) ABSTRACT

The present invention relates to a candy product in the sense of hard or soft candy of a new candy material, comprising at least two components (a) and (b), which may have at least one interface to each other in the candy product and therewith may form a composition of alternating compositions (a)/(b)/(a) etc. in the candy product, and which contains alcohol or alcoholic liquids in this candy material, wherein the alcohol or alcoholic liquids in the component (b) is bound in a carrier matrix and substantially homogeneous distributed throughout the solid candy material. Furthermore, the present invention relates to a process for producing such candy products.

The present invention relates to a candy product in the sense of hard or soft candies of a new candy material, comprising at least two components (a) and (b), which may have at least one interface to each other in the candy product and therewith may form preferably a composition of alternating composition (a)/(b)/(a) etc. in the candy product and which contains alcohol or alcoholic liquids in this candy material, wherein the alcohol or alcoholic liquids in the component (b) is bound in a carrier matrix and substantially homogeneous distributed throughout the solid candy material. Furthermore, the present invention relates to a process for producing such candy products.

Candy products, such as candies or lollipops, containing liquid ingredients, such as alcohol, are already known in principle. Up to now, candy products having liquid or alcoholic ingredients have been produced by making a candy product having a cavity or a core-shell structure, in which the liquid or alcoholic components are present as filling in the cavity or core which is surrounded by a wrapping material, wherein the liquid alcohol is present in the candy product in a kind of encapsulation.

Candy products, such as chewing gums or sweets having such a core-shell structure, which contain alcohol in a cavity as a liquid or soft core wrapped in a solid shell, are known for example from WO 2008/105908 A, US 2009/0074911 A, EP 2 305 742 A, AU 2010/210005 A, US 2009/0150231 A, WO 98/47483 A and U.S. Pat. No. 7,641,926 B.

Further such alcoholic sweets having a core-shell structure are known, for example, from DE 10 2012 209159 concerning an alcohol-filled lollipop; from GB 2 355 641 relating to sweets having an alcoholic filling coated with a 2-layer sweet shell; from DE 299 08 058 U1 concerning candies having an alcoholic filling; from FR 587 969 concerning filled candy products having a sugar-containing body filled with an alcoholic liquid; from NL 7 412 492 concerning candy products having liquid alcohol filling; or from GB 2 196 828 relating to a candy product with a sugar-based outer gelatin body having a cavity in which a second soft shaped body is embedded, which e.g. includes an alcoholic solution.

Also confectionery, pralines, ice cream or chocolate molded articles having liquid alcohol filling in the form of a core-shell structure, wherein the alcoholic filling is enclosed in a cavity in the candy product, are known, e.g. from US 2010/119660 concerning chocolate molded articles containing an aroma substance, such as Wine, encapsulated in a coating; from GB 2 463 658 concerning confectionery based on fatty components, such of chocolate, having alcoholic filling in the form of liquid-filled cavities; from EP 0 064 155 concerning filled confectionery, wherein two shell halves enclose a liquid filling; from WO 2004/010791 concerning frozen sweet products such as an ice cream mass, for example having a chocolate coating, in which capsules having a liquid filling are incorporated; from WO 2015/101970 concerning chocolate matrices incorporated in the droplets of a liquid filling which are encapsulated by a wrapper; from EP 0 398 279 concerning sugar-free crust pralines in which a water-alcohol mixture with polyols and thickening agents is processed into a crust praline; or from confectionery, vol. 24.10; 1980 “Alcoholic pralines and their processing techniques” (Gopel G.).

Furthermore, candy products in the form of extrusion molded articles are known from WO 2011/104564 or from EP 0965274, wherein these extrusion molded articles can have cavities which e.g. can be filled with an alcoholic liquid. Thus, the alcohol-containing extrusion molded articles described here also have the shell-core structure described above having a liquid-filled cavity.

A disadvantage of such candy products known from the prior art, is that in each case only the inner core or the cavity contains the liquid components such as alcohol. When such confectionery is consumed, the consumer must first penetrate or dissolve the wrapping structure before the taste experience of the alcoholic components, present in the core, is revealed to him. In this case, the liquid alcoholic filling usually occurs very directly and in high concentration only in a very short time interval of consumption, i.e.

the liquid alcoholic filling is only released with dissolution, e.g. by sucking or biting of the encapsulation or shell structure, at once and almost completely and usually is swallowed directly. A lasting taste experience, which enables the enjoyment of the alcohol flavor over the entire period of eating the candy or lollipop, and optionally also in a much more moderate flavor dosage, is not achievable thereby.

It is thus desirable to provide a candy product in which the liquid, in particular the alcoholic ingredients are already contained in the shell, mantle or candy product material itself and thus may be distributed in a substantially homogeneous manner throughout the whole candy product, so that when consuming such candy products, the taste sensation of the alcohol flavor is given from the beginning of consumption and over the entire consumption period.

WO 2011/027103 discloses confectionery having a porous structure, wherein a filling can be introduced into the pores. The production of such porous structures is achieved by foaming the confectionery materials and then filling the desired fillers in the pores. Such a process is technically complex and the feasibility depends on the basic foamability of the confectionery materials to be used and furthermore involves the difficulty of producing sufficiently mechanically stable foams which maintain a stable porosity even when filled with the desired filling material.

WO 2001/28359 discloses alcoholic confectionery in the form of jelly sugar confectionery, in which an aqueous-alcoholic sugar solution is mixed with an agar-sugar solution and liqueurs, fruit pastes and fruit jellies, which are coated with chocolates, are produced from this mixture.

Object of the present invention is therefore to eliminate the disadvantages of the prior art, and in particular to provide a new candy product, which does not have the above disadvantages and which can be obtained in particular by a new, simpler manufacturing process. This candy product should comprise a candy material in which the alcohol is substantially distributed throughout the whole solid candy material, thus, in the solid portion of the candy, and releasable for consumption for nearly the entire period of consumption, without the alcohol contained therein evaporating during production and/or storage.

This object is achieved by using a new and specially prepared candy material, which can be used to form the candy products according to the invention, as well as by the new inventive process for producing such new candy products.

The underlying object of the present invention is solved by the features of independent claim 1. Preferred embodiments of the invention are specified in the subclaims or will be described in more detail below.

The invention relates to a candy product in the sense of a hard or soft candy comprising at least two components (a) and (b), wherein
(a) is an alcohol-free component containing at least one sugar, sugar substitute, sugar-like substance or mixtures thereof, and
(b) is a component containing a mixture of ethanol or an alcoholic liquid in a carrier matrix is,
   wherein the components (a) and (b) may each have an interface to each other in the candy product, and wherein the components (a) and (b) each exist as a solid component in the candy product and thus form a candy product having an in total massive candy material, wherein the alcohol or alcoholic liquids are substantially homogeneously distributed throughout the whole solid candy material.

The invention relates also, for example, to a candy product comprising at least two components (a) and (b), wherein
(a) is an alcohol-free component containing at least one sugar, sugar substitute, sugar-like substance or mixtures thereof, and
(b) is a component containing a mixture of ethanol or an alcoholic liquid having at least one sugar, sugar substitute, sugar-like substance or mixtures thereof,
   wherein the components (a) and (b) have at least one interface to each other in the candy product.

The candy products according to the invention are characterized in particular in that the components (a) and (b) are each solid and together form a solid candy material. In particular, the component (b) is characterized in that alcohol is substantially homogeneously distributed in a suitable carrier matrix, as defined below, and this component (b) is embedded in the component (a) so that an in total massive and solid candy material having a substantially homogeneous distribution of the alcohol is present, from which, when consuming (dissolving the candy material), the alcohol is released over the almost entire consumption period. For this purpose, the alcohol is mixed in liquid form with the material of the carrier matrix of the component (b) by intensive stirring, so that the alcohol is substantially homogeneously distributed and bound in the carrier matrix.

The term candy product in the sense of the present invention generally includes confectionery from the group of candies, such as hard caramels, especially candies, lollipops and drops, as well as soft candies, especially chewy candies, as well as toffees and fudge, such as outlined in the definition of the BLL guideline for sugar confectionery (BLL—Confederation for Food Law and Foodstuff e. V., Guideline for Sugar Confectionery, May 2012). By way of clarification, it should be noted that the term “candy product” according to the invention is not limited to sugar-containing candy products, but also includes those which contain additionally, predominantly or exclusively, sugar substitutes and/or sugar-like substances as defined below. In particular, candy products according to the present invention comprise sweets which dissolve in the mouth (for example when chewing or sucking) preferably no chewing gum is included within the term of candy product according to the invention. Likewise, preferably not included by the inventive term of candy products, are chocolate-based sweets such as Pralines, confectionery, chocolate molded articles or ice cream and jelly sugar products. The candy products according to the invention are preferably in the form of hard candies, more preferably as candy or lollipop, particularly preferably in the form of a lollipop.

According to the definition of “Confectionery Technology, Department of Confectionery 2013; ZDS Solingen “are hard candies sugar confectionery, which can be obtained by boiling sucrose-glucose syrup solutions to a residual water content of 1-3% with the addition of various flavoring agents, fruit acids and/or value-determining additives such as milk, honey, malt or similar. Hard candies are highly concentrated, amorphous glassy solidified melts of sugars of different molecular weight, which maintain their shape in a liquid or plastic state. They are characterized by a vitreous structure having splintered fracture and have due to their very low water vapor pressure a very low equilibrium moisture content (GF value=<30%) and are therefore very hygroscopic. Hard candies are very durable under optimal conditions. Basic requirements for the durability are:
low water content
optimal ratio of sucrose to glucose syrup
low hygroscopicity
absence of crystal germs.

Soft candies or chewy candies differ from hard candies in principle only in their consistency, optionally soft candies contain up to 15% fat and emulsifiers. According to “Die Welt der Zuckerwaren” (The World of Sugar Confectionery), published by the BDSI—Federal Association of the German Confectionery Industry, Specialty sugar confectionery, (December 1999), a distinction is made between hard candies (hard candies or candies having a residual water content of about 3%) and soft candies (soft and chewy candies or candies having a residual water content of about 10%), depending on the residual water content, resulting in a different “texture”, so that hard candies are more products for sucking, soft candies, however, are rather products for chewing.

In the production of so-called sugar-free hard candies (or soft candies) the usable carbohydrates (sugar) are replaced by sugar substitutes. The country-specific legislation on the authorization of sugar substitutes must be observed. Thus, products containing more than 9.9% sugar alcohols as sugar substitutes must be given a warning in Europe about their laxative effects.

The term molded articles in the sense of the present invention encompasses all three-dimensional bodies, in particular geometric bodies such as spherical, cuboid, cubic, pyramidal, prismatic, cylindrical, delta-like, conical, toroidal, paraboloidal and hyperboloidal body but also non-geometric body such as ovoid or fractal body formed from the candy material of the present invention.

The term candy material in the sense of the present invention also refers to a precursor of the candy products according to the invention, wherein the candy material may be in solid, viscous, moldable, viscoplastic, spreadable or flowable form and which comprises at least two components (a) and (b) in the candy material, which may have at least one interface to each other. Such a viscous, moldable, viscoplastic, spreadable or flowable precursor of the candy material can be solidified by cooling and/or solidification and thus converted into a molded article of the candy product according to the invention to obtain the candy product according to the invention.

According to the invention, the component (a), which is forming the candy-molded article of the candy material, is preferably resistant (inert) to alcohol, and alcoholic fillings.

The component (a) of the candy products according to the invention is solid and free of alcohol and contains at least one sugar, sugar substitute, sugar-like substance or mixtures thereof.

The component (b) of the candy products according to the invention is solid as well and contains a mixture of ethanol or an alcoholic liquid in a suitable carrier matrix. Suitable materials of the carrier matrix of the component (b) include sugars, sugar substitutes, sugar-like substances, thickening and binding agents, hydrocolloids, each as defined below, or mixtures thereof. The component (b) is preferably obtained by admixing or stirring in or rather mixing or stirring the liquid ethanol or the alcohol-containing liquid into or rather with the material of the carrier matrix. Preferably, the material of the carrier matrix is selected from a solid or powdered sugar, sugar substitute, sugar-like substance, thickener or mixtures thereof. Powder-shaped here preferably denotes a fine bulk material having a particle size of up to about 1 mm and comprises powders and dusts as well as crystalline particulate bulk material.

In the sense of the present invention, the term “solid” describes, in connection with the components (a), (b) or with the candy products or the candy material, a solid state of aggregation at room temperature and up to the preferred processing temperature. In particular, the components (a), (b) or the candy products or the candy material according to the invention are solid (in particular not flowable) at room temperature (20° C.±5° C.). Solid also denotes dimensionally stable, elastic states at room temperature or up to the preferred processing temperature, such as soft candies and chewy candies exhibit. For example, solid, in connection with the candy products according to the invention in the form of hard and soft candies, can describe a state with a modulus of elasticity of >300 Pa, preferably >400 Pa.

The term sugar (saccharides) within the meaning of the present invention comprises sweet-tasting water-soluble mono-, di- and oligosaccharides such as, in particular, glucose, fructose, dextrose, galactose, lactose, sucrose and maltose.

Sugar substitutes within the meaning of the present inventions comprise, according to the definition according to “Sü [symbol] warenentechnologie, Fachbereich Zuckerwaren 2013; ZDS-Solingen” (Confectionery Technology, Department of Sugar Confectionery 2013; ZDS Solingen), Polyols, also known as sugar alcohols or polyalcohols, which are sweet-tasting compounds but do not exhibit the reactions typical of sugars (saccharides). They are obtained from mono- and disaccharides, as well as from the starch saccharification products by reduction of the carboxyl group. Examples of sugar substitutes include sorbitol, xylitol, maltitol, mannitol, isomalt, erythritol, lactitol.

The term isomalt in the sense of the present invention comprises a sugar substitute.

Isomalt is obtained by catalytic hydrogenation of isomaltose (palatinose) and is a mixture of α-d-glucopyranosido-1,6-sorbitol and α-d-glucopyranosido-1,6-mannitol. Isomalt is also commercially available under the trademark Palatinit®.

Sorbitol or sorbitol is a sugar substitute from the group of sugar alcohols and is the reduced polyol form of the hexoses glucose, fructose and sorbose and can be prepared from these by catalytic or electrochemical hydrogenation.

Sugar-like substances in the sense of the present invention include sugar-like degradation products of starch, whether it is wheat, corn or rice starch or tapioca starch, which have a chain length of the dextrose molecules, corresponding to the oligosaccharide chain length or higher. Examples include dextrins, maltodextrins and polydextrins, such as tapioca starch based maltodextrins. Sugar-like substances in the sense of the present invention also include polydextrose and sugar esters.

The term polydextrose in the context of the present invention denotes a long-chain sugar-like synthetic compound of glucose, sorbitol and citric acid and is approved in the EU as a food additive under the name E 1200.

The term sugar ester refers to esters of inorganic or organic acids with saccharides, which are preferably prepared from sucrose (simple table sugar) and certain fatty acids (including stearic, palmitic acid) for use in foods.

Preferably, the sugars, sugar substitutes and sugar-like substances of the component (a) and/or the carrier matrix of the component (b) are selected from the group consisting of glucose, fructose, dextrose, galactose, lactose, sucrose, maltose, sorbitol, xylitol, maltitol, Mannitol, isomalt, erythritol, lactitol, dextrins, maltodextrins, polydextrins, polydextrose and mixtures thereof. Preference is given to glucose, isomalt, maltitol, sorbitol, dextrin and polydextrose as well as maltodextrin (in particular based on tapioca starch).

The component (a) of the candy products according to the invention preferably comprises isomalt or sorbitol or mixtures thereof. In addition, in a particularly preferred embodiment, the component (a) may also comprise polydextrose and/or sugar esters.

The materials of the carrier matrix of the component (b) of the candy products according to the invention are preferably sugars, sugar substitutes or sugar-like substances selected from the group comprising maltitol, sorbitol, isomalt, dextrin, maltodextrin (in particular based on tapioca starch), polydextrose and mixtures thereof; Thickening and binding agents selected from the group defined below, preferably from the group comprising celluloses, such as microcrystalline cellulose, methyl-, ethyl-, hydroxypropyl-, hydroxypropylmethyl-, methylethyl-, carboxymethyl-, sodium carboxymethylcellulose and cellulose ethers; Thickening agents from the group of hydrocolloids as defined below, preferably from the group comprising xanthan, locust bean gum; or mixtures thereof. Preferably, the carrier matrix of the component (b) comprises at least one constituent from the group of sugars, sugar substitutes and sugar-like substances as defined herein, which has an advantageous effect on the flavor of the candy.

The sugars, sugar substitutes and/or sugar-like substances can in principle be used in granular, crystalline, pulverized, molten or liquefied form or mixtures thereof. According to the invention, the sugar, sugar substitutes and/or sugar-like substances are used in granular, crystalline form or in the form of a powder (as defined above) in particular for the preparation of the component (b).

Within the meaning of the present invention, alcohol comprises ethanol as well as alcohol-based liquids and all alcoholic products (for example alcoholic beverages or beverage preparations) and alcoholic raw materials which have a minimum alcohol content of 10% by volume or up to 30% by volume and a maximum amount of pure ethanol. In particular, edible alcoholic liquids are meant.

A mixture of at least one material of the carrier matrix as defined above and alcohol in the context of the present invention denotes a mixture in the sense of a mixture or a blend. Preferably, a mixture of at least one material of the carrier matrix as defined above and alcohol in the sense of the present invention does not comprise a porous structure of the material of the carrier matrix in which the alcohol is filled. Thus, it is particularly preferred that the mixture of at least one material of the carrier matrix as defined above and alcohol as well as the component (b) or the candy layer (b) produced therefrom is non-porous.

According to the invention, the component (a) and/or the component (b) in addition to the constituents mentioned above also comprise other ingredients, such as in particular one or more other food additives.

The number and selection of the other food additives results inter glia from the flavor of the final product to be produced and the desired shape and stability of the candy product and can be varied within wide ranges.

In the context of the present invention, food additives of the components (a) and/or (b) can be selected from the group consisting of thickeners, flavoring agents, dyes, sweeteners, acidifying agents, dairy products, coloring foods and mixtures thereof.

Thickeners (also referred to as thickening agents or binders) include all food-approved thickeners, preferably thickeners are selected from the group consisting of alginic acid, alginates (sodium, potassium, calcium, ammonium, propylene glycol alginate), agar-agar, Carrageenan, locust bean gum, guar gum, tragacanth, gum arabic, xanthan, karaya, tara gum, gellan, pectins, celluloses (microcrystalline cellulose, methyl-, ethyl-, hydroxypropyl-, hydroxypropylmethyl-, methylethyl-, carboxymethyl-, sodium carboxymethylcellulose), cellulose ethers, gelatin, Sago and strength. Thickeners from the group of hydrocolloids include, for example, starch, cellulose, pectins, gum arabic, galactomannans, guar gum, locust bean gum, agar-agar, carrageenan, alginates, gelatin, xanthan and dextrans. Preferably, the thickener is selected from the group comprising xanthan, locust bean gum, carboxymethylcellulose such as sodium carboxymethylcellulose, hydroxypropylcellulose and cellulose ethers. Preferred thickening agents for the carrier matrix of the component (b) are selected from the group comprising xanthan, locust bean gum, carboxymethylcellulose such as sodium carboxymethylcellulose, hydroxypropylcellulose, cellulose ethers or mixtures thereof. Celluloses in solid form or in powder form are preferably used therein. Preferred hydrocolloid gels of the carrier matrix in the component (b) include gels of xanthan or locust bean gum.

Acidifying agents include all food-approved acidifying agents, preferably acidifying agents are selected from the group consisting of malic acid, tartaric acid, citric acid and lactic acid, in particular lactic acid.

Sweeteners include all food-approved sweeteners such as acesulfame, aspartame, aspartame-acesulfame salt, cyclamate, neohesperidin, neotame, saccharin, sucralose, stevioside (stevia), thaumatin, preferably sweeteners are selected from the group consisting of aspartame, acesulfame, saccharin and stevia.

Dairy products include all food-approved dairy products, preferably dairy products selected from the group consisting of milk (as well as products of milk and milk components), condensed milk, whipped cream and milk powder.

Another preferred ingredient of the candy material of the present invention is water. The water is generally required for the preparation of the component (a) and/or (b) of the candy material and can, due to production factors, remain in the component (a) or (b) and thus in the candy product according to the invention, wherein, in the production of hard candies the total water content in the final product is at most 3% by weight, based on the components (a) and (b) of the candy product in total. In the production of soft candies, the water content in the final product may be up to a total of up to 10% by weight, based on the components (a) and (b) of the candy product in total. Any water-containing fillings are disregarded. In general, is the water content higher in the production and it is reduced in each case by the incorporation of the components (a) and (b) in the preparation of the candy material in order to set the particular desired toughness. The component (b) is preferably kept substantially anhydrous, both in the preparation of the component (b), as well as in the candy material and in the final product. In particular, the component (b) preferably has a water content of at most 0.5% by weight.

Preferred embodiments according to the invention relate to candy products in which the at least two components (a) and (b) are present in two or more, preferably three or more substantially alternating or successive layers. In such embodiments, the component (a) defined according to the invention corresponds then to a layer (a) having a corresponding composition and the component (b) defined according to the invention corresponds to a layer (b) having a corresponding composition. If, in the context of the present invention, a layer (a) or (b) is mentioned, it has thus the composition corresponding to the component (a) or (b).

In order that the alcohol contained in the component (b) does not evaporate too quickly or as little as possible up to not at all during the production, packaging and/or storage, it is preferred that the candy products exhibit on their outsides the component (a). In a preferred two-, three- or multi-layer embodiment according to the invention, the outermost layer of the candy product according to the invention is thus preferably formed from the component (a). The molded articles formed from the candy material can be massively solid, for example, as a massive candy or massive lollipop.

A further preferred embodiment relates to a candy product according to the invention, wherein the candy product, consisting of the alternating components (a)/(b)/(a) . . . etc. or from the multi-layered successive components (a)/(b)/(a) . . . etc. in the form of a hollow body or a shell, which encloses a cavity or core, which in addition contains a solid, semi-solid, flowable or liquid filling (c), in particular a flowable or liquid alcoholic filling (c). In such embodiments, the innermost layer that forms the interface with the filling (c) is preferably formed from the component (a). In such embodiments, wherein the multilayer candy material according to the invention forms with the components (a) and (b) additionally a hollow body filled with a filling (c), are thus both, the outermost layer and the innermost layer, formed of the component (a).

It is also possible that the two components (a) and (b) form a massive “compressed material” in the candy material, in which the alcohol is present substantially homogeneously distributed without that individual layers or interfaces between the components (a) and (b) are visible. Such compressed materials can also be formed as massive molded articles (massive candies or lollipops) or as hollow bodies (containing a possible additional filling compound (c), as described above).

The term alcoholic filling in the context of the present invention encompasses all fillings, in particular liquid, viscous, syrupy, gelatinous and particulate fillings which contain alcohol in the form of ethanol.

The component (a) preferably consists predominantly of the at least one sugar, sugar substitute, sugar-like substance or the mixtures thereof, wherein usual food-approved auxiliaries and additives such as the above, may be added. Preferably, dairy products are added to component (a) as defined above.

The component (b) preferably consists predominantly of the material of the carrier matrix, such as the at least one sugar, sugar substitute, sugar-like substance, thickener or hydrocolloid gel or the mixtures thereof, wherein usual food-approved auxiliaries and additives, such as the above, may be added.

The amount of the at least one sugar, sugar substitute, sugar-like substance or the mixture thereof in the alcohol-free component (a) is preferably 65 to 100% by weight, more preferably 90 to 99% by weight, most preferably 93 to 96% by weight, in each case based on the total component (a) in the candy product according to the invention, in particular to achieve the resistance of the candy product to the alcohol and alcoholic liquids or fillings contained in the component (b) and optionally in the core.

The amount of the carrier matrix, e.g. of the at least one sugar, sugar substitute, sugar-like substance, thickening agent, hydrocolloid gel or the mixture thereof, in the component (b) may be 40 to <100% by weight, 50 to 90% by weight, 60 to 80% by weight, in each case based on the total component (b) in the candy product according to the invention, in particular in order to receive and bind the alcohol or alcoholic liquids therein and keep them, for processing into a molded article, substantially homogeneously distributed therein. Depending on the selected carrier matrix material, however, it can also be chosen significantly lower. The decisive factor is an amount which enables a suitable viscosity adjustment of the component (b).

The amount of the ethanol or the alcoholic liquid in the component (b) can be from 0.1 to 60% by weight, from 10 to 50% by weight, from 20 to 40% by weight, in each case based on the total component (b) in the candy product according to the invention. Depending on the selected carrier matrix material, however, it can also be chosen to be significantly higher, for example in the range from 10 to 98% by weight or up to 95% by weight. The alcohol content in the entire candy material comprising the components (a) and (b) may be 0.1 to 50% by weight, 0.1 to 40% by weight, 0.1 to 30% by weight, 0.1 to 20% by weight, 0.1 to 10% by weight, 0.1 to 5% by weight, or 0.5 to 50% by weight, 0.5 to 40% by weight, 0.5 to 30% by weight, 0.5 to 20% by weight, 0.5 to 10% by weight, 0.5 to 5% by weight, or 1.0 to 50% by weight 1.0 to 40% by weight, 1.0 to 30% by weight, 1.0 to 20% by weight, 1.0 to 10% by weight, 1.0 to 5% by weight, in each case relative to the total candy material (without possible additional alcoholic filling), in order to produce a taste experience of the alcohol flavor, in particular when the candy product or candy material according to the invention are consumed.

In embodiments wherein the candy material of the candy product of the present invention is in the form of a hollow body or shell enclosing a core or a filling (c), an alcoholic filling (c) is preferably provided. Such an alcoholic filling preferably comprises glucose syrup, maltitol syrup or sorbitol (or mixtures thereof), which gives the filling a sweet taste. The glucose syrup content, maltitol syrup content or the sorbitol content of such an alcoholic filling is preferably from 55 to 99% by weight, in particular from 61 to 96% by weight, based in each case on the complete filling material (c).

Such an alcoholic filling (c) comprises alcohol in addition to glucose syrup, maltitol syrup and/or sorbitol, wherein the alcohol content in such an alcoholic filling in a core of the molded article is preferably 2 to 40% by weight, in particular 5 to 35% by weight, in each case based on the total filling material (c) in the core.

Such alcoholic fillings may further comprise at least one food additive as defined above. The number and choice of food additives will depend on the flavor of the final product to be produced and may vary widely and, in particular, include the above-defined food additives.

In the context of the present invention, the at least one food additive of the filling material (c) in the core can in particular be selected from the group consisting of flavoring agents, dyes, in particular titanium dioxide, acidifying agents, dairy products, sweeteners, thickeners and mixtures thereof.

If dairy products are contained in the core of a filling (c) according to the invention, the amount is preferably 0.1 to 15% by weight, in each case based on the total filling material (c) in the core.

If an acidifying agent is contained in the core of a filling (c) according to the invention, the amount is preferably 0.1 to 5% by weight, in particular 0.5 to 3% by weight, in each case based on the total filling material (c) in the core.

Another object of the present invention is a process for the preparation of the molded articles according to the invention, which comprises the following process steps:
(1) preparation of a viscous, moldable, viscoplastic, spreadable or flowable mass of the alcohol-free component (a) by heating a mixture or melt of the desired constituents of the component (a);
(2) Preparation of the component (b) by providing the material of the carrier matrix, preferably selected from at least one sugar, sugar substitute, sugar-like substance, thickener, hydrocolloid gel or mixtures thereof, each as defined above, optionally admixing further additives, stirring in the ethanol or the alcoholic liquid in the material of the carrier matrix to obtain a substantially homogeneous viscous, moldable, viscoplastic, spreadable or flowable mixture;
(3) Embedding or enclosing the component (b) of step (2) in the viscous, moldable, viscoplastic, spreadable or flowable mass of the alcohol-free component (a) of step (1) to form a candy material comprising the components (a) and (b) each having an interface to each other and wherein the alcohol is substantially homogeneously distributed;
(4) Shaping the candy material obtained from step (3) to obtain a molded article which may optionally be in the form of a hollow body having at least one opening;
(5) optionally providing a filling material (c);
(6) optionally filling the filling material (c) from step (5) into the molded article in the form of a hollow body having at least one opening from step (4) and closing the at least one opening of the molded article;
(7) optionally providing a stick into the molded article from step (4) or (6)
(8) cooling the molded article to obtain the candy product.

For the preparation of the component (a) in step (1), at first the at least one sugar, sugar substitute, sugar-like substance or mixtures thereof and water, in the weight % ratio of generally 75:25 (sugar/sugar substitute/sugar-like substance:water) to 99:1, in particular in the weight ratio of 90:10 to 99.5:0.5, are cooked in a batch cooker or in a cook-stirrer at temperatures between 150° C. and 170° C., for example at 170° C. Parallel or subsequently, a vacuum is applied to reduce the water content.

Thereafter, the vacuum is vented and, if necessary, the desired for the respective end product additional food additives are added, and blended in a flavor mixing device, e.g. from Ruffinatti®, or mixed manually.

The mass of the alcohol-free component (a) from step (1) is preferably present in the form of a melt (for example sugar melt) of the at least one sugar, sugar substitute, sugar-like substance or the mixture thereof.

For the preparation of the component (b) in step (2) at first the materials of the carrier matrix, as defined above, as preferably the at least one particular powdered sugar, sugar substitute, sugar-like substance, the powdery thickener, the hydrocolloid gel or mixtures thereof, optionally with the respective food additives desired for the end product, in particular with e.g. a thickening agent such as preferably xanthan, are mixed and with the alcohol (ethanol or an alcoholic liquid) with intensive stirring homogeneously mixed.

Preferably, the preparation of the component (b) take place in step (2), by stirring in the ethanol or alcoholic liquid in a solid or powdered material of the carrier matrix, which is selected from the group comprising solid or powdered sugar, sugar substitutes or sugar-like substances, as above defined, solid or powdery thickeners from the group of celluloses, in particular hydroxypropyl cellulose and sodium carboxymethyl cellulose, and cellulose ethers.

In step (3), the embedding or enclosing of the alcohol-containing component (b) from step (2) in the flowable mass of the alcohol-free component (a) from step (1) takes place to form a flowable or soft or plastic-moldable candy material in which the components (a) and (b) may have at least one interface to each other, and wherein the alcohol is substantially homogeneously distributed.

In a process variation (3a), the enclosing of the mass of the component (b) can be carried out by surrounding or wrapping the mixture of the component (b) from step (2) with a topcoat of the mass of the alcohol-free component (a). As a result, according to step (3a), a massive two-layer candy product can be obtained by completely wrapping or encasing a possibly preformed amount of the component (b) from the component (a) from step (1). In this case, the component (a) forms a type of shell-layer around of a type solid core, formed from the component (b), as shown schematically in FIG. 1. Such embodiments have no cavity formed from the component (a) and filled with a liquid, and thus differ from known sweets having a liquid-filled shell-core structure, as described above.

In a process variation (3b), in particular a three-layered or multi-layered sugar candy material can be produced. Therein, at first, the viscous, moldable, viscoplastic, spreadable or flowable component (a) from step (1) is spread or poured out, and then a layer of the viscous, moldable, viscoplastic, spreadable or flowable component (b) is applied by brushing or pouring. The preparation of the layers of the components (a) and (b) may be accomplished by conventional techniques such as casting, spreading, squeegeeing, spraying, etc. Preferably, the layers can be applied to one another at a processing temperature of about 70 to 85° C., more preferably 70 to 75° C., since the components (a) and (b) from step (1) or (2) at this temperature have optimal processing plasticity and suitable viscosity.

In a process variation (3b) i) the embedding of the component (b) takes place by applying the viscous, moldable, viscoplastic, spreadable or flowable component (b) from step (2) on a layer of viscous, moldable, viscoplastic, spreadable or flowable mass of the alcohol-free component (a) from step (1) and applying at least one further layer of the viscous, moldable, viscoplastic, spreadable or flowable mass of the alcohol-free component (a) on the layer of the component (b), optionally applying further layers of the components (b) and (a), wherein the outermost layers of the candy material formed in this way, are formed of the alcohol-free component (a).

Thereby, the layer of the component (b) is enclosed by two layers of the component (a). Due to the subsequent application of further alternating layers of the components (b) and (a), basically any number of further layers (b) and (a) can be obtained in alternating order in the same way, so that a multi-layered candy material with alternating layers (a), (b), (a), etc. can be obtained, wherein the top layer is preferably formed from a layer (a), so that preferably the outermost layers are formed of the component (a), as shown schematically in FIG. 2.

In a process variation (3b) ii), the embedding of the component (b) takes place by applying the viscous, moldable, viscoplastic, spreadable or flowable component (b) from step (2) to a layer of viscous, moldable, viscoplastic, spreadable or flowable mass of the alcohol-free component (a) of step (1) and curling the layered candy material thus formed, wherein the outermost layer of the multilayered roll formed in this way, is formed of the alcohol-free component (a).

Therein, for example, an initially produced two-layered layer material comprising a layer (a) and a layer (b) is rolled in, so that a type of multi-layered screw, as shown schematically in FIG. 3, is formed. The rolling of the two superimposed layers (a) and (b) takes place in such a way that the layer (a) is rolled over the lying there on layer (b) and thereby the outermost layer of the roll or screw thus formed is formed from the component (a). In principle, it is also possible at first to produce a three-layered or multi-layered candy material (for example as described in variation (3b) i), and to roll up this three-layered or multilayered layer material accordingly. In addition, it is possible to carry out the rolling over a rod or a pipe or a correspondingly suitable workpiece, so that a cavity is formed within the screw. This cavity can then be filled with a filling (c), similar to what follows.

In a process variation (3b) iii), the embedding of the component (b) takes place by applying the viscous, moldable, viscoplastic, spreadable or flowable component (b) on a layer of viscous, moldable, viscoplastic, spreadable or flowable mass of the non-alcoholic component (a) and folding the layered candy material thus formed, such that a multi-layered candy material is formed, wherein the outermost layer of the candy material thus formed is formed of the alcohol-free component (a).

Therein, for example, an initially produced two-layered layer material comprising a layer (a) and a layer (b) is folded over one another (laminated) one or more times, so that a flat, multi-layered candy material, as shown schematically in FIG. 4, is formed. The folding of the two-layered sheet material can be carried out by using known folding techniques, such as for example from the production of puff pastries or for croissants. The folding is carried out in such a way that the layer (a) comes to rest over the lying thereon layer (b) and thereby forming the respectively outermost layers of the candy material thus formed from the component (a). In principle, it is also possible first to produce a three-layered or multi-layered candy material (for example as described in variation (3b) i), and to fold this three-layered or multilayered layer material accordingly. In addition, it is possible to perform the folding over a rod or pipe or a suitably suitable workpiece, so that a cavity is formed within the folded candy material. This cavity can then be filled with a filling (c), similar to what follows.

A candy material can be produced in a process variation (3c) in which the component (b) is substantially homogeneously distributed in the component (a), as shown schematically in FIG. 5. Therein, the enclosing or embedding of the component (b) takes place by dropwise addition, stirring or kneading of the initially prepared component (b) in the viscous, moldable, viscoplastic, spreadable or flowable mass of the alcohol-free component (a).

In principle, the enclosing or embedding of the component (b) in the component (a) can be carried out by known processes for the preparation of hard and soft candies. Thus, in a process variation (3d) it is also possible and preferred to twist strands of the viscous, moldable, viscoplastic, spreadable or flowable components (a) and (b) together and to process them in suitable conical rollers or leveling rolls to form a multilayer candy material or to knead them, wherein the components (a) and (b) are in substantially alternating layers. Strands of components (a) and (b) are preferably combined in a ratio of 80:20 to 20:80% by weight, more preferably 70:30 to 30:70% by weight, even more preferably 60:40 to 40:60% by weight.

Depending on the process, the laminating, layering, twisting and kneading of the components (a) and (b), as described in the preceding process variations, also lead to a candy material in which the two components (a) and (b) are compressed together that interfaces or individual layers are no longer readily recognizable. Such compressed materials are also characterized by a substantially homogeneous distribution of the alcohol in the entire compressed candy material, wherein the alcohol is enclosed storage-stable and thus also has the above-mentioned advantages of the present invention.

The candy material obtained in step (3) may optionally be additionally coated with the component (a).

Preference is given to the process variation (3b), very particular preference is given to the variation (3b) iii), in which the layer material is folded, as well as the process variation (3d) and a procedure to give a compressed product.

The candy material obtained according to the process variation of step (3) is formed in step (4) into the desired molded articles according to the invention. Deformation is carried out by known shaping processes, such as e.g. using a conical roller to form a strand from the candy material produced in step (3) (preferably at temperatures between 55 and 65° C.), using leveling rolls for rejuvenating and further shaping the preformed candy material, e.g. in the form of a strand, (preferably at temperatures between 40 and 45° C.). Instead of a conical roller an extruder can also be used.

Subsequently, a portioning or cutting done can occur, for example by means of embossing machines. By cutting, embossing, twisting or squeezing of the preformed candy material, e.g. in the form of a strand, the desired shapes and/or parts can be obtained. This process is preferably carried out under cooling or followed by cooling to temperatures between 16 and 18° C.

For embodiments wherein the candy material formed from the components (a) and (b) forms a hollow body or shell, enclosing a core with an alcoholic filling, the candy material is shaped to the molded article, preferably by incorporating the candy material from step (3) in a conical roller, which is provided with a filling tube, and which is designed so that a hollow body of the candy material can be formed, in which through the filling tube, the filling compound (c) from step (5) can be filled (pumped) into the molded article. Basically, this process for producing filled hollow sugar products is known. Instead of a cone roller can also be used here an extruder.

As already mentioned above, it is also possible to form the hollow body formed from the components (a) and (b) by rolling up or folding according to process variations (3b) ii) and iii) or (3d) via a suitable workpiece like a rod or a tube through which the cavity is formed. Also in this variation, a filling tube can be used, through which the filling material (c) from step (5) can be filled (pumped) into the molded article.

In step (5), in order to prepare a filling material for the core of corresponding filled molded articles according to the invention, the filler base, such as glucose syrup, maltitol syrup or sorbitol, optionally with the addition of further additives, in particular thickeners as defined above, is being first cooked at temperatures between 100° C. and 130° C., for example at 120° C. in a batch cooker or a cook-stirrer. As a result, the water content of the filling material is regulated and the toughness of the filling material is adjusted. The lower the amount of water, the tougher is the filling mass.

If the filling material (c) contains dairy products for the core, these are first mixed with the glucose syrup, the maltitol syrup and/or the sorbitol and optionally with the further additives, in particular thickeners, and cooked at temperatures between 100° C. and 130° C., for example, at 110° C.

Subsequently, the filling material (c) for the core is cooled to temperatures less than 78° C. and the required food additives for each end product are added and mixed.

Finally, alcohol (ethanol or an alcoholic liquid) is additionally added to the filling material (c) for the core. The temperature is still lower than 78° C. to prevent boiling of the alcohol.

In step (6), if necessary, the filling compound (c) for the core is filled (pumped), for example, through the filling tube of the cone roller in the hollow molded article produced from the candy material according to the invention. The filling material has a temperature of less than 78° C. when it is filled into the hollow body.

The at least one opening of the shell molded article is then closed. This can be accomplished, for example, by cutting, embossing, twisting or squeezing the preformed filled candy material, e.g. in the form of a filled strand. In this process, the desired shapes and/or parts of the filled candy products can be obtained. After the filling material has been filled into the shell molded article and the at least one opening has been closed, the mixture is cooled to 20 to 40° C.

By cooling the shaped and optionally filled candy material the candy product according to the invention is obtained. The cooling does not necessarily have to be done as a last step, but can also take place during or continuously in the course of shaping, filling and/or sealing and portioning.

In embodiments which are formed in the form of a lollipop, a stick is pressed into the still-tough-plastic candy material in step (7). It can be made massive lollipops or filled with a filling (c).

In particular, by suitably adjusting of the residual water content, candy product in the form of hard or soft candies as defined herein can be obtained in the processes described above.

Thereafter, the finished product is cooled and completed e.g. packaged in suitable packaging materials.

The invention also relates to the candy products obtainable by the process described above, in particular in the form of hard and/or soft candies, as defined above.

The present invention includes, for example, the following embodiments:

1. Candy product, comprising at least two components (a) and (b), wherein
(a) is an alcohol-free component containing at least one sugar, sugar substitute, sugar-like substance or mixtures thereof, and
(b) is a component containing a mixture of ethanol or an alcoholic liquid having at least one sugar, sugar substitute, sugar-like substance or mixtures thereof,
   wherein the components (a) and (b) have at least one interface to each other in the candy article.

2. Candy product according to embodiment 1, wherein the at least one sugar, sugar substitute or sugar-like substance of the component (a) and/or (b) is selected from the group consisting of glucose, fructose, dextrose, galactose, lactose, sucrose, maltose, sorbitol, xylitol, maltitol, mannitol, isomalt, erythritol, lactitol, dextrins, maltodextrins, polydextrins, polydextrose and mixtures thereof, preferably selected from the group consisting of glucose, isomalt, sorbitol and polydextrose.

3. Candy product according to embodiment 1 or 2, wherein the components (a) and (b) are present in two or more successive layers.

4. Candy product according to any of the preceding embodiments, wherein the candy product exhibits on its outer sides, the component (a).

5. Candy product according to any one of the preceding embodiments, wherein the components (a) and/or (b) comprise one or more additives selected from the group consisting of thickeners, flavors, dyes, sweeteners, acidifying agents, dairy products, coloring foods and mixtures thereof.

6. Candy product according to any of the preceding embodiments, which is in the form of a hard candy, a candy, a lollipop, a soft candy, or a chewy candy, which may also be in the form of a shell enclosing a core, which may contain a filling (c), wherein the filling (c) is preferably an alcoholic filling.

7. Candy product according to one of the preceding embodiments, characterized in that the amount of the at least one sugar, sugar substitute, sugar-like substance or the mixture thereof in the alcohol-free component (a) is 65 to 100% by weight, based on the component (a).

8. Candy product according to one of the preceding embodiments, characterized in that the amount of the at least one sugar, sugar substitute, sugar-like substance or the mixture thereof in the component (b) is 40 to <100% by weight, based on the component (b).

9. Candy product according to one of the preceding embodiments, characterized in that the amount of the ethanol or the alcoholic liquid in the component (b) is 0.1 to 60% by weight, based on the component (b).

10. A process for producing a candy product according to any one of embodiments 1 to 9, which comprises the following process steps:
(1) preparing a flowable mass of the alcohol-free component (a) by heating a mixture of the ingredients of the component (a);
(2) preparing the component (b) by providing the at least one sugar, sugar substitute, sugar-like substance or mixtures thereof, each in the form of a powder, optionally admixing further additives, stirring in the ethanol or alcoholic liquid to obtain a substantially homogeneous mixture;
(3) embedding or enclosing the component (b) of step (2) in the flowable mass of the alcohol-free component (a) of step (1) to form a candy material in which the components (a) and (b) have at least one interface to each other;
(4) shaping the candy material obtained from step (3) to obtain a molded article which may optionally be in the form of a shell having at least one opening;
(5) optionally providing a filling material (c);
(6) optionally filling the filling material (c) from step (5) in the molded article in the form of a shell having at least one opening of step (4) and closing the at least one opening of the molded article;
(7) optionally providing a stick into the molded article from step (4) or (6)
(8) cooling the molded article to obtain the candy product.

11. Process according to embodiment 10, wherein in step (3) the embedding of the mass of the component (b) is carried out by surrounding the component (b) with a covering layer of the mass of the alcohol-free component (a).

12. Process according to embodiment 10, wherein in step (3) the embedding of the component (b) is carried out by applying the component (b) to a layer of the flowable mass of the alcohol-free component (a) and applying at least one further layer of the flowable mass of the alcohol-free component (a) on the layer of the component (b), optionally applying further layers of the components (b) and (a), wherein the outermost layers of the candy material thus formed, are formed from the alcohol-free component (a).

13. Process of embodiment 10, wherein in step (3) the embedding of the component (b) is carried out by applying the component (b) to a layer of the flowable mass of the alcohol-free component (a) and curling the layered candy material thus formed, wherein the outermost layer the multilayered roll thus formed is formed of the alcohol-free component (a).

14. Process according to embodiment 10, wherein in step (3) the embedding of the component (b) is carried out by applying the component (b) to a layer of the flowable mass of the alcohol-free component (a) and folding the layered candy material thus formed, such that a multi-layered candy material is formed, wherein the outermost layer of the candy material thus formed, is formed from the alcohol-free component (a).

15. Process according to embodiment 10, wherein in step (3) the enclosing or embedding of the component (b) is carried out by dropping, stirring in or kneading the component (b) into the flowable mass of alcohol-free component (a).

The present invention will be further illustrated by the following examples, which, however, do not limit the present invention.

### DESCRIPTION OF THE FIGURES

The reference numerals used in the description of the figures have the following meaning:

(a) Component/Layer (a)

(b) Component/Layer (b)

FIG. 1: Cross section through a candy product according to the invention, obtainable as described in process variation (3a)

FIG. 2: Cross section through a multilayer candy product according to the invention, obtainable by applying a plurality of layers of the components (a) and (b), as described in process variation (3b) i)

FIG. 3: Cross section through a multilayer candy product according to the invention, obtainable by rolling in the layer-like applied components (a) and (b), as described in process variation (3b) ii)

FIG. 4: Cross section through a multilayer candy product according to the invention, obtainable by folding the layer-like applied components (a) and (b), as described in process variation (3b) iii)

FIG. 5: Cross section through a candy product according to the invention, obtainable by stirring in or kneading the component (b) into a mass of the component (a), as described in process variation (3c)

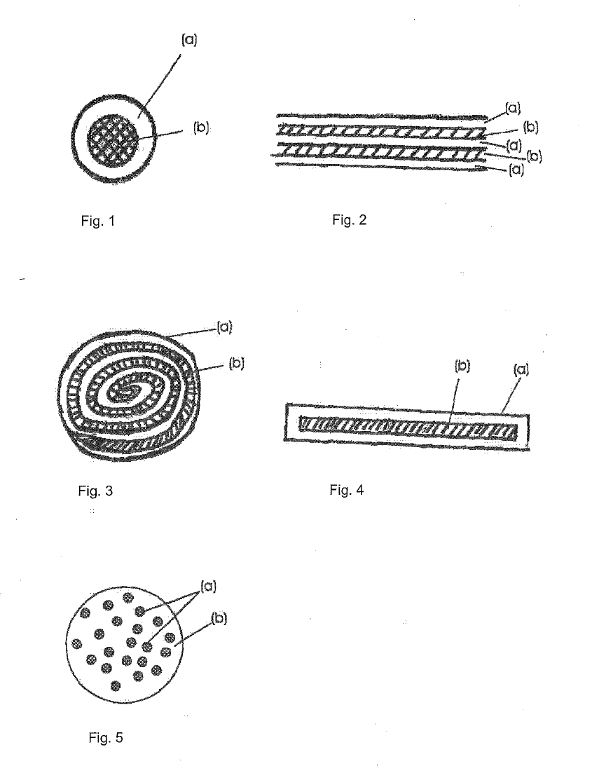

### EXAMPLES

The following examples relate to candy products according to the invention comprising at least two components (a) and (b), wherein
(a) is an alcohol-free component comprising at least one sugar, sugar substitute, sugar-like substance or mixtures thereof, and
(b) is a component comprising a mixture of ethanol or an alcoholic liquid with a carrier matrix material selected from at least one sugar, sugar substitute, sugar-like substance, thickener, hydrocolloid gel or mixtures thereof,
   wherein the components (a) and (b) may have at least one interface to each other in the candy product and are each present as a massive, solid component in the candy product.

### Example 1: Candy Product without Alcoholic Filling in a Core

A candy product according to the invention, having a composition according to Table 1 and 2, in the form of a candy or lollipop according to the composition of Table 3 and according to the process variation (3b) iii) was prepared.

TABLE 1
Component (a)
After the cooking process

| | Amount |
|---|---|
| Raw material | [% by weight] |
| Isomalt | 79.0 |
| Polydextrose | 14.0 |
| Sorbitol | 6.0 |
| Water | 1.0 |

TABLE 2
Component (b)

| | Amount |
|---|---|
| Raw material | [% by weight] |
| Polydextrose | 66.67 |
| Alcohol | 33.33 |

The components (a) and (b) were prepared according to the compositions shown in Tables 1 and 2.

The component (a) was obtained by admixing isomalt, sorbitol and polydextrose with water (cooking mass) and boiling at 165° C. in a batch cooker. Optionally, further food additives, as defined above, are added and stirred with the cooking mass in a flavor mixing device.

The component (b) was prepared by mixing polydextrose and alcohol.

Subsequently, the component (a) was spread flat and over it the component (b) was spread. From the thus obtained two-layer candy material, a multi-layered candy material was produced by folding the layers one above the other, which was then converted into the desired shape in a conical roller and by means of leveling rolls and embossing machines. In embodiments in the form of a lollipop, a stick is then pressed into the still viscoplastic candy material.

The resulting candy product can be packaged after cooling.

TABLE 3
Composition of the candy product (total)

| | Amount |
|---|---|
| Total | [% by weight] |
| Component (a) total | 87.67 |
| Component (b) total | 12.33 |

Alcohol content in the candy product (total): 4.11% by weight

### Example 2: Candy Product Having Core with Alcoholic Filling (20% Alcohol Content in the Filling)

The candy material was prepared according to Example 1.

In addition, according to the composition according to Table 4, a filling material (c) for the alcoholic filling of a candy product according to the invention in the form of a filled candy or a filled lollipop according to the composition of Table 5 was prepared.

TABLE 4
Filling (c) (“alcoholic filling”)

| | Amount |
|---|---|
| Raw material | [% by weight] |
| Maltitol syrup | 75.00 |
| Alcohol | 25.00 |

Instead of maltitol syrup, glucose syrup or sorbitol can also be used for the filling. Optionally, other food additives, as defined above, may also be added and stirred with the filling material.

The alcohol-containing filling thus obtained is pumped via a filling tube attached to the conical roller into the hollow molded article made of the candy material produced in the conical roller. The at least one opening of the filled molded article is closed by cutting or squeezing. In embodiments in the form of a lollipop, a stick is then pressed into the still viscoplastic candy material.

The resulting candy product can be packaged after cooling.

TABLE 5
Composition of the candy product (total)

| | Amount |
|---|---|
| Total | [% by weight] |
| Candy material | 80.00 |
| (total) | |
| alcohol-containing | 20.00 |
| filling | |

Alcohol content in the candy material in total (components (a)+(b)): 4.11% by weight Alcohol content in the candy product in total (components (a)+(b)+alcoholic filling): 8.29% by weight.

### Example 3: Other Candy Products, Optionally Producible as a Hollow Body with Alcoholic Filling or without Filling, According to the Above Examples 1 and 2 with Varying Component (b)

TABLE 3
further possible components (b)

| | | Amount |
|---|---|---|
| Example | Raw material | [% by weight] |
| 3-1 | Polydextrose | 17.5 |
| | Dextrin | 41 |
| | Cellulose ethers | 1.8 |
| | Alcohol | 39.7 |
| 3-2 | Hydroxypropylcellulose | 5 |
| | Alcohol | 95 |
| 3-3 | Hydroxypropylcellulose | 65 |
| | Alcohol | 35 |
| 3-4 | Component 3-3 | 72 |
| | Polydextrose | 28 |
| 3-5 | Component 3-4 | 72 |
| | Polydextrose | 28 |
| 3-6 | Polydextrose | 34 |
| | Alcohol | 66 |
| 3-7 | Maltodextrin based on | 30 |
| | tapioca starch | |
| | Alcohol | 70 |

The above components (b) of Table 3 can be prepared with the components (a) of Examples 1 and 2 or with other suitable compositions for forming the component (a) according to the invention in order to form the candy products according to the invention. Processes as described in Examples 1 and 2 or one of the other methods of the invention described, can be used. The described components may be used to make candy products in the form of candies or lollipops, as described herein.

Result:

All exemplary embodiments are easy to process and can be processed into the candy products according to the invention, in particular in the form of hard candies. The candy products thus available are characterized by a continuous and stable release of the alcohol over the entire consumption period and even after a long storage time.

1-15. (canceled)

16: A candy product, which is in the form of a hard candy, a drop, a lollipop, a soft candy or a chewy candy, comprising at least two components (a) and, (b), wherein
(a) is an alcohol-free component containing at least one selected from the group consisting of a sugar, a sugar substitute, a sugar-like substance and combinations thereof, and
(b) is a component containing a mixture of ethanol or an alcoholic liquid in a carrier matrix,
which together form an overall solid candy material, wherein the alcohol or alcoholic liquids are present in component (b) bound to the carrier matrix and are substantially homogeneously distributed throughout the solid candy material.

17: The candy product of claim 16, wherein components (a) and (b) are present in three or more alternating layers.

18: The candy product of claim 16, wherein component (a) is present at an outer surface of the candy product.

19: The candy product of claim 17, wherein component (a) is present at an outer surface of the candy product.

20: The candy product of claim 16, wherein the candy product has the form of a hollow body containing a filling (c), wherein the filling (c) is a liquid or flowable alcoholic filling.

21: The candy product of claim 16, wherein the carrier matrix of component (b) is selected from the group consisting of solid sugar, powdered sugar, sugar substitute, sugar-like substance, cellulose, microcrystalline cellulose, methyl cellulose, ethyl cellulose, hydroxypropyl cellulose, hydroxypropylmethyl cellulose, methylethyl cellulose, carboxymethyl cellulose, sodium carboxymethylcellulose, or cellulose ethers, and hydrocolloid gels.

22: The candy product of claim 21, wherein the carrier matrix of component (b) is selected from a sugar-substitute or sugar-like substance, selected from sorbitol, xylitol, maltitol, mannitol, isomalt, erythritol and lactitol.

23: The candy product of claim 16, wherein at least one of component (a) and component (b) further comprises at least one additive selected from the group consisting of thickening agents, flavoring agents, colorants, sweeteners, acidifying agents, dairy products, and coloring foods.

24: The candy product of claim 16, wherein the amount of the at least one sugar, sugar substitute, sugar-like substance or the mixture thereof in the alcohol-free component (a) is 65 to 100% by weight, based on the component (a).

25: The candy product of claim 21, wherein the amount of the at least one sugar, sugar substitute, sugar-like substance or the mixture thereof in the alcohol-free component (a) is 65 to 100% by weight, based on the component (a).

26: The candy product of claim 16, wherein the amount of the ethanol or the alcoholic liquid in the component (b) is 10 to 95% by weight, based on the component (b).

27: A process for producing the candy product of claim 16, the process comprising the steps of:
(1) preparing a viscous, moldable, viscoplastic, spreadable or flowable mass of the alcohol-free component (a) by heating a mixture or melt of the desired constituents of component (a);
(2) preparing component (b) by providing the material of the carrier matrix, optionally admixing further additives, stirring the ethanol or alcoholic liquid into the material of the carrier matrix to obtain a substantially homogeneous viscous, moldable, viscoplastic, flowable or spreadable mixture;
(3) embedding or enclosing component (b) of step (2) in the viscous, moldable, viscoplastic, spreadable or flowable mass of the alcohol-free component (a) of step (1) to form a candy material in which the components (a) and (b) each may have an interface to each other and wherein the alcohol is substantially homogeneously distributed throughout the entirety of the candy material;
(4) shaping the candy material obtained from step (3) to obtain a molded article, which may optionally be in the form of a hollow body having at least one opening;
(5) optionally providing a filling material (c);
(6) optionally filling the filling material (c) from step (5) into the molded article in the form of a hollow body having at least one opening of step (4) and closing the at least one opening of the molded article;
(7) optionally inserting a stick into the molded article of step (4) or (6); and
(8) cooling the molded article to obtain the candy product.

28: The process of claim 27, wherein the mass of the alcohol-free component (a) of step (1) is a melt of at least one sugar, sugar substitute, sugar-like substance or a mixture thereof.

29: The process of claim 27, wherein in step (2) the preparation of component (b) comprises mixing the ethanol or alcoholic liquid into a solid or powdered material of the carrier matrix which is selected from the group consisting of solid or powdered sugars, sugar substitutes or sugar-like substances, solid or powdered thickening agents selected from the group consisting of cellulose, microcrystalline cellulose, methyl cellulose, ethyl cellulose, hydroxypropyl cellulose, hydroxypropylmethyl cellulose, methylethyl cellulose, carboxymethyl cellulose, sodium carboxymethylcellulose, or cellulose ethers.

30: The process of claim 28, wherein in step (2) the preparation of component (b) comprises mixing the ethanol or alcoholic liquid into a solid or powdered material of the carrier matrix which is selected from the group consisting of solid or powdered sugars, sugar substitutes or sugar-like substances, solid or powdered thickening agents selected from the group consisting of cellulose, microcrystalline cellulose, methyl cellulose, ethyl cellulose, hydroxypropyl cellulose, hydroxypropylmethyl cellulose, methylethyl cellulose, carboxymethyl cellulose, sodium carboxymethylcellulose, or cellulose ethers.

31: The process of claim 27, wherein in step (3) embedding the component (b) is carried out by applying the component (b) on a layer of the flowable mass of the alcohol-free component (a) and applying at least one further layer of the flowable mass of the alcohol-free component (a) on the layer of component (b), optionally applying further layers of components (b) and (a), whereby outermost layers of the thus formed three- or multi-layered candy material are formed from the alcohol-free component (a).

32: The process of claim 27, wherein in step (3) embedding the component (b) is carried out by applying the component (b) to a layer of the flowable mass of the alcohol-free component (a) and rolling or twisting and kneading the thus formed multilayer candy material, wherein an outermost layer of a multilayered roll or a twisted strand thus formed is formed of the alcohol-free component (a).

33: The process of claim 27, wherein in step (3) embedding the component (b) is carried out by applying component (b) to a layer of the flowable mass of the alcohol-free component (a) and folding the layered candy material thus formed, such that a multi-layered candy material is formed, wherein the outermost layer of the candy material thus formed is formed of the alcohol-free component (a).

34: The process of claim 27, wherein in step (3) embedding the component (b) is carried out by applying the component (b) on a layer of the flowable mass of the alcohol-free component (a) and applying at least one further layer of the flowable mass of the alcohol-free component (a) on the layer of component (b), optionally applying further layers of components (b) and (a), whereby outermost layers of the thus formed three- or multi-layered candy material are formed from the alcohol-free component (a).

35: The process of claim 30, wherein in step (3) embedding the component (b) is carried out by applying the component (b) to a layer of the flowable mass of the alcohol-free component (a) and rolling or twisting and kneading the thus formed multilayer candy material, wherein an outermost layer of a multilayered roll or a twisted strand thus formed is formed of the alcohol-free component (a).
